(19) United States
(12) Patent Application Publication
(10) Pub. No.: US 2012/0099811 A1
(43) Pub. Date: Apr. 26, 2012

(54) BEARING ASSEMBLY WITH ROTATION SENSOR

(76) Inventor: Hiroyoshi Ito, Mie (JP)

(21) Appl. No.: 13/379,074

(22) PCT Filed: Jul. 1, 2010
(86) PCT No.: PCT/JP2010/061245

§ 371 Date: Dec. 19, 2011

(30) Foreign Application Priority Data
Jul. 6, 2009 (JP) 2009-159677

(51) Int. Cl. G01P 13/00; F16C 19/00

(52) U.S. Cl. 384/448

(57) ABSTRACT

A bearing assembly with a rotation sensor is proposed which can be fixed to a stationary member in the form of a thin plate formed with a through hole for positioning the bearing assembly so that its outer race can be easily rotationally fixed to the stationary member. The bearing assembly includes a stationary member (7) in the form of a thin plate member formed with a through hole (7a) extending in the thickness direction of the thin plate member and defining a radially inner portion (7b) capable of radially positioning a radially outer portion (4d) of the outer race (4) of the rolling bearing (1), and a snap ring (8) fitted in a ring groove (4a) formed in the outer race (4). The stationary member (7) has an anti-rotation portion (7c, 22) which is configured to be inserted between circumferentially spaced apart ends (8a, 15d) of the snap ring (8) or the sensor case (5) with the rolling bearing (1) mounted between the radially inner portion (7b) and a rotary shaft (9). The anti-rotation portion (7c, 22) thus prevents rotation of the outer race (4) by circumferentially engaging either of the circumferentially spaced apart ends (8a, 15d).

### TECHNICAL FIELD

This invention relates to a bearing assembly comprising a rolling bearing and a magnetic rotation sensor mounted on the rolling bearing.

### BACKGROUND ART

Patent document 1 shows a typical bearing assembly of this type, which includes a magnetic encoder member mounted to the inner race of the rolling bearing at one end thereof, a sensor case mounted to the outer race of the rolling at the one end thereof, and a sensor board assembly fixed to the sensor case. The magnetic encoder member has a magnetized portion having a plurality of magnetic poles arranged in the circumferential direction. The sensor board assembly includes a circuit board, and a magnetic sensor mounted on the circuit board such that with the sensor case mounted on the outer race, the magnetic sensor faces the magnetized portion.

This type of bearing assembly is used to support a rotary shaft so as to be able to detect its rotational speed. During use, in order to detect the rotation with the magnetic sensor, it is necessary to keep the outer race of the rolling bearing stationary. That is, in order to maintain stable positional relationship between the magnetic sensor and the magnetic encoder, it is necessary not only to position the inner and outer races in both axial directions and radial directions, but to prevent rotation of the outer race. If the radially outer portion of the outer race can be fitted in a stationary member over a wide area, such as in a housing, the outer race can be rotationally fixed to a stationary member by e.g. interference fit or due to frictional engagement between the fitting portions under load. Ordinarily, it is possible to prevent relative rotation between the inner race and the rotary shaft by interference fit.

### PRIOR ART DOCUMENTS

### Patent Documents

Patent document 1: JP Patent Publication 2005-256892A

### SUMMARY OF THE INVENTION

### Object of the Invention

But there is an occasion on which it is desirable to use a stationary member for supporting the outer race of the rolling bearing which comprises a thin plate formed with a through hole extending in the thickness direction of the thin plate and defining a radially inner portion for radially positioning the radially outer portion of the outer race. For example, partitioning walls defining a photosensitive drum chamber in office machines such as printers comprise thin plates, and a photosensitive drum shaft, which is a rotary shaft, extends through these partitioning walls. If one of these partitioning walls is used as the above stationary member, the fitting width between the outer race and the radially inner portion of the stationary member is too short to stably rotationally fix the outer race.

An object of the present invention is to provide a bearing assembly with a rotation sensor which can be fixed to a stationary member in the form of a thin plate formed with a through hole for positioning the bearing assembly so that its outer race can be easily rotationally fixed to the stationary member.

According to the present invention, there is provided a bearing assembly with a rotation sensor comprising a rolling bearing including an inner race and an outer race, a magnetic encoder member mounted to the inner race at a first end of the bearing, a sensor case mounted to the outer race at the first end of the bearing, and a sensor board assembly fixed to the sensor case, wherein the magnetic encoder member includes a magnetized portion including a plurality of magnetic poles arranged in the circumferential direction, wherein the sensor board assembly comprises a circuit board and a magnetic sensor mounted on the circuit board, and wherein the sensor case is mounted such that the magnetic sensor faces the magnetized portion, characterized in that the bearing assembly further comprises a stationary member comprising a thin plate member formed with a through hole extending in the thickness direction of the thin plate member and defining a radially inner portion capable of radially positioning a radially outer portion of the outer race of the rolling bearing, and a first snap ring fitted in a ring groove formed in the outer race of the rolling bearing, and that with the rolling bearing mounted between the radially inner portion of the stationary member and a rotary shaft, the stationary member is configured to engage one of the first snap ring and the sensor case so as to prevent rotation of the outer race of the rolling bearing. As used herein, “thin plate” refers to a rolled metal sheet having a thickness of 5 mm or less.

According to this invention, based on the finding that if radial loads small enough to be able to radially position the radially outer portion of the outer race of the rolling bearing, which is a stationary bearing race, are supported by the radially inner portion of the through hole extending in the thickness direction of the stationary member, which is in the form of a thin plate, the strength by which the outer race is fixed to the snap ring or the sensor case is larger than the force necessary to rotationally fix the outer race, e.g. the snap ring is used to easily rotationally fix the outer race. That is, the snap ring fitted in the ring groove of the outer race has a fitting strength large enough to position the bearing assembly in the axial direction by tightening the outer race. The sensor case mounted on the outer race at the first end thereof is has a fitting strength large enough to ensure sufficient detection accuracy of the magnetic sensor. Since either of these members is capable of supporting torque of the outer race, it is possible to prevent rotation of the outer race by the engagement between the snap ring or the sensor case and the stationary member. The stationary member and the snap ring are both used to position the bearing assembly with the rotation sensor, while the sensor case is used to position the sensor board assembly. Since it is possible to position the rolling bearing using the stationary member, which comprises a thin plate formed with a through hole for positioning extending in its thickness direction, and also possible to prevent rotation of the outer race using component parts of the bearing assembly and the members for positioning the bearing assembly, the outer race can be easily prevented from rotating.

As a first means for preventing rotation of the outer race, the stationary member includes an anti-rotation portion protruding toward one of the first snap ring and the sensor case, and the one of the first snap ring and the sensor case is formed with circumferentially spaced apart ends. In this arrangement, the anti-rotation portion is configured to circumferentially engage one of the circumferentially spaced apart ends, thereby preventing rotation of the outer race of the rolling bearing. With this arrangement, simply by mounting the rolling bearing with the anti-rotation portion of the stationary member axially aligned with the circumferentially spaced apart ends of the snap ring or the sensor, the anti-rotation portion engages one of the circumferentially spaced apart ends, thus preventing rotation of the outer race.

The first snap ring may be formed with the circumferentially spaced apart ends, and the anti-rotation portion may be configured to be inserted between the circumferentially spaced apart ends. Since the circumferentially spaced apart ends of the snap ring, which are formed so that the snap ring can be easily fitted in position, are used as engaging portions, the stationary member can be brought into engagement with the snap ring simply by forming the anti-rotation portion on the stationary member.

In an alternative arrangement, the sensor case comprises an annular casing member formed with the circumferentially spaced apart ends, and an fixing auxiliary member, wherein the casing member has a protrusion fitted in a seal groove formed in the outer race at the first end thereof, wherein with the protrusion fitted in the seal groove, the fixing auxiliary member is configured to prevent deformation of the casing member such that the circumferentially spaced apart ends move toward each other, thereby keeping the protrusion in the seal groove, and wherein the anti-rotation portion is configured to be inserted between the circumferentially spaced apart ends of the sensor case. Since the circumferentially spaced apart ends of the sensor case, which are formed so that the sensor case can be easily fitted in position, are used as engaging portions, the stationary member can be brought into engagement with the snap ring simply by forming the anti-rotation portion on the stationary member.

As a second means for preventing rotation of the outer race, the stationary member is formed with a cutout in the inner periphery of the through hole so as to extend radially outwardly from the radially inner portion, and the one of the first snap ring and the sensor case is formed with an extension/protrusion configured to be inserted into the cutout, whereby the outer race of the rolling bearing is prevented from rotating by the engagement between the cutout and the extension/protrusion. The cutout can be formed simultaneously when forming the through hole in the thin plate. With this arrangement, simply by mounting the rolling bearing with the cutout and the extension/protrusion axially aligned with each other, the extension/protrusion engages in the cutout, thus preventing rotation of the outer race.

As a third means for preventing rotation of the outer race, the bearing assembly further comprises a second snap ring configured to be fitted around the outer race of the rolling bearing with the rolling bearing mounted between the radially inner portion of the stationary member and the rotary shaft, wherein the first and second snap rings engage two opposed sides of the stationary member so as to sandwich the stationary member, thereby preventing rotation of the outer race of the rolling bearing due to friction between the first and second snap rings and the stationary member. Since the stationary member is simply sandwiched between the two snap rings, this arrangement does not limit the circumferential position of the rolling beating when the rolling bearing is inserted into the stationary member, as in the case of the anti-rotation portion or the cutout.

Since the inner race is fitted around the rotary shaft, there is a sufficient fitting width therebetween. But additional means may be used to prevent relative rotation between the inner race and the rotary shaft.

For example, the magnetized portion of the magnetic encoder member may be supported on one side of the outer periphery of the inner race of the rolling bearing, and the sensor case may have an outer annular portion supported on one side of the inner periphery of the outer race of the rolling bearing. In this case, the bearing assembly further comprises a pair of shaft-side snap rings fitted on the rotary shaft, and a sleeve fitted on the rotary shaft, wherein the sleeve is configured to be inserted between the sensor case and the rotary shaft and between the magnetic encoder member and the rotary shaft until the sleeve abuts the inner race of the rolling bearing, and the pair of shaft-side snap rings sandwich the inner race and the sleeve together, thereby preventing rotation of the inner race relative to the rotary shaft due to friction between one of the shaft-side snap rings and the inner race and between the other of the shaft-side snap rings and the sleeve. With this arrangement, it is possible to prevent rotation of the inner race relative to the rotary shaft using the shaft-side snap rings, which are used to axially position the bearing assembly.

As a different means for preventing relative rotation between the inner race and the rotary shaft, the bearing assembly further comprises an O-ring fitted in a circumferential groove formed in the outer periphery of the rotary shaft, wherein the O-ring is compressed by a radially inner portion of the inner race of the rolling bearing, whereby the inner race is prevented from rotating relative to the rotary shaft due to friction between the O-ring and the radially inner portion of the inner race. With this arrangement, it is possible to prevent relative rotation between the inner race and the rotary shaft independently of the structure of e.g. the sensor case.

Generally speaking, wiring connected to the sensor board assembly when inserting the bearing assembly into the stationary member tends to interfere with the insertion of the bearing assembly.

Thus it is preferable that the sensor board assembly further comprise a connector to which a wiring connector is connected from outside the sensor case. With this arrangement, since wiring can be connected after inserting the rolling bearing, the wiring does not interfere with the insertion of the bearing.

The connector is preferably mounted on the same side of the circuit board that the magnetic sensor is mounted. Since the sensor and the connector are mounted on the surface of the circuit board, they can be easily mounted on the circuit board by soldering in a shorter period of time, compared to insertion mounting.

Wires such as signal wires and a power source wire are connected separately or in the form of a single cable to the sensor board assembly. In order to avoid the rotary shaft, these wires are ordinarily run from the sensor case to one side or in one of the directions perpendicular to the axial direction along the axial direction.

Preferably, the circuit board has a first circuit pattern on which the connector can be mounted with its front side facing toward one side, and a second circuit pattern on which the connector can be mounted with its front side facing in a direction perpendicular to the axis of the bearing assembly, and the circuit board is configured such that the positional relationship between the magnetic sensor and the sensor case when the connector is mounted on the first circuit pattern is identical to the positional relationship between the magnetic sensor and the sensor case when the connector is mounted on the second circuit pattern. With this arrangement, it is possible to cope with either of the above two ways to run the wires, and thus to reduce the number of parts.

The position of the magnetic sensor on the circuit board is determined by the position of the magnetized portion. The position of the connector on the circuit board is determined within the range in which its front side faces in either of the above two directions and is exposed to the outside of the sensor case. If the above two circuit patterns are formed on one side of the circuit board, the larger the distance between the connector and the sensor case, the less complicated the wire connections are. But this distance should be as short as possible in order to minimize the mounting space of the bearing assembly by minimizing the portion of the connector protruding from the sensor case.

Preferably, the first and second circuit patterns are provided on one and the other sides of the circuit board, respectively. With this arrangement, it is possible to minimize the distance between the connector and the magnetic sensor and also minimize complication of wire connections.

Preferably, the sensor case and the sensor board assembly are configured such that the sensor case and the sensor board assembly can be inserted through the through hole of the stationary member from either of the opposed axial directions. With this arrangement, when the rolling bearing is inserted with no wire connections, the rolling bearing can be inserted into the through hole of the stationary member from the side of the rolling bearing or from the side of the sensor case.

The connector and the component parts related to the two circuit patterns can be used in any bearing assembly of this type, and also can be used in a bearing assembly of which the outer race is rotated and the inner race is stationary.

### Advantages of the Invention

According to this invention, by the provision of a stationary member comprising a thin plate member formed with a through hole extending in the thickness direction of the thin plate member and defining a radially inner portion capable of radially positioning a radially outer portion of the outer race of the rolling bearing, and a first snap ring fitted in a ring groove formed in the outer race of the rolling bearing such that with the rolling bearing mounted between the radially inner portion of the stationary member and a rotary shaft, the stationary member is configured to engage one of the first snap ring and the sensor case so as to prevent rotation of the outer race of the rolling bearing, it is possible to position the rolling bearing with the stationary member while preventing rotation of the outer race of the rolling bearing with a simple manner.

### BRIEF DESCRIPTION OF THE DRAWINGS

FIG. 1 is a vertical sectional front view of a bearing assembly with a rotation sensor according to a first embodiment of the present invention.

FIG. 2 is a right-hand side view of FIG. 1.

FIG. 3 is a right-hand side view of a sensor case of the bearing assembly of the first embodiment.

FIG. 4 is a plan view of a sensor board assembly of the bearing assembly of the first embodiment, showing the state in which one side of the circuit board of the sensor board assembly is used.

FIG. 5 is a plan view of the sensor board assembly, showing the state in which the other side of the circuit board is used.

FIG. 6 is a vertical sectional front view of the bearing assembly of the first embodiment, showing the state in which the other side of the circuit board is used.

FIG. 7(a) is a left-hand side view of a stationary member of the bearing assembly of the first embodiment; and FIG. 7(b) is a sectional view taken along line a-a of FIG. 7(a).

FIG. 8 is a left-hand side view of FIG. 1.

FIG. 9 is a vertical sectional front view of a bearing assembly with a rotation sensor according to a second embodiment of the present invention.

FIG. 10 is a right-hand side view of FIG. 9.

FIG. 11 is a vertical sectional front view of a bearing assembly with a rotation sensor according to a third embodiment of the present invention.

FIG. 12(a) is a left-hand side view of a stationary member of the bearing assembly of the third embodiment; and FIG. 12(b) is a sectional view taken along line b-b of FIG. 12(a).

FIG. 13 is a left-hand side view of FIG. 11.

FIG. 14 is a right-hand side view of FIG. 11.

FIG. 15 is a vertical sectional front view of a bearing assembly with a rotation sensor according to a fourth embodiment of the present invention.

FIG. 16 is a right-hand side view of FIG. 15.

FIG. 17(a) is a left-hand side view of a stationary member of the bearing assembly of the fourth embodiment; and FIG. 17(b) is a sectional view taken along line c-c of FIG. 17(a).

FIG. 18 is a vertical sectional front view of a bearing assembly with a rotation sensor according to a fifth embodiment of the present invention.

FIG. 19 is a left-hand side view of FIG. 18.

FIG. 20 is a right-hand side view of FIG. 18.

FIG. 21 is a vertical sectional front view of a bearing assembly with a rotation sensor according to a sixth embodiment of the present invention.

FIG. 22 is a right-hand side view of FIG. 21.

FIG. 23 is a vertical sectional front view of a modification of the sixth embodiment.

### BEST MODE FOR EMBODYING THE INVENTION

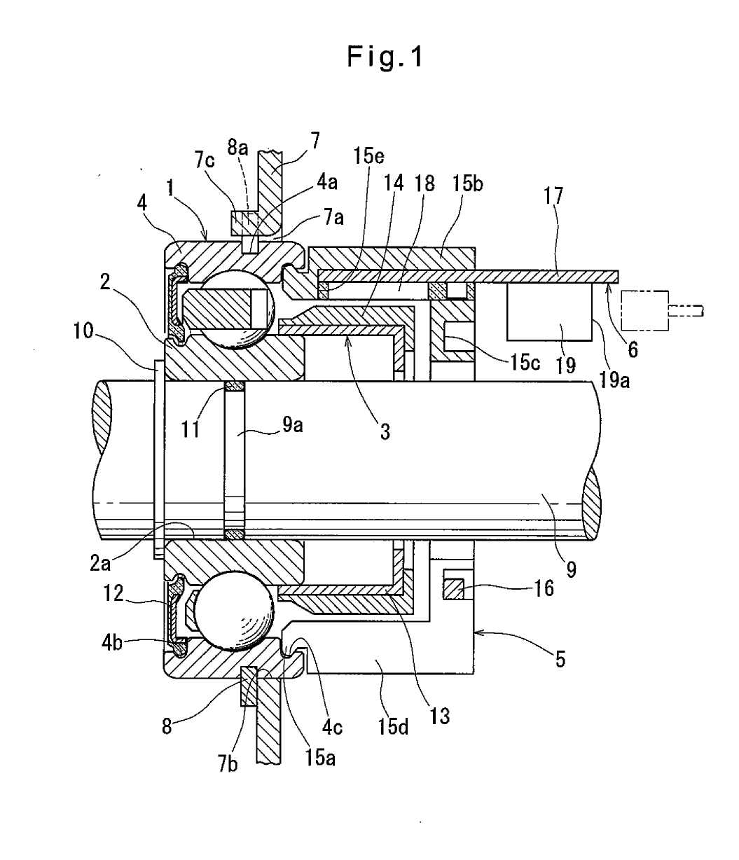

As shown in FIG. 1, the bearing assembly with a rotation sensor according to the first embodiment includes a rolling bearing 1, a magnetic encoder member 3 mounted on an inner race 2 of the rolling bearing 1 at a first end thereof, a sensor case 5 mounted on an outer race 4 of the rolling bearing 1 at the first end thereof, sensor board assembly 6 fixed to the sensor case 5, a stationary member 7 comprising a thin plate, a snap ring 8 fitted in a ring groove 4a formed in the outer race 4, a shaft-side snap ring 10 fitted on a rotary shaft 9, and an O-ring 11 fitted in a circumferential groove 9a formed on the outer peripheral surface of the rotary shaft 9.

The rolling bearing 1 is a non-separable bearing capable of supporting both radial and axial loads.

The outer race 4 has seal grooves 4b and 4c at the respective ends of the inner periphery thereof. A seal 12 is fitted in the seal groove 4b, which is located at the second end of the bearing. The sensor case 5 is fitted in the seal groove 4c, which is located at the first end of the bearing.

The magnetic encoder member 3 includes a magnetized portion 14 which comprises a rubber magnet formed on the radially outer surface of a metal core 13 by vulcanization and having a plurality of magnetic poles. The rubber magnet is made of a rubber material in which magnetic powder is kneaded. The magnetic poles in the magnetized portion 14 can be arranged in any desired pattern. Ordinarily, N and S poles are alternately arranged over the entire circumferential direction around the axis of the bearing.

The magnetic encoder member 3 is mounted on the first end of the inner race 2 by fitting the metal core 13 on the radially outer surface of the inner race 2 at its first end. Once mounted in position in this manner, the magnetic encoder member 3 never contacts the rotary shaft 9 with the inner race 2 fitted on the rotary shaft 9, and the magnetized portion 14 is supported in position by the metal core 13 so as to extend to one side from the outer periphery of the inner race 2. The magnetized portion 14 may be supported by a relatively hard rubber member instead of the metal core 13.

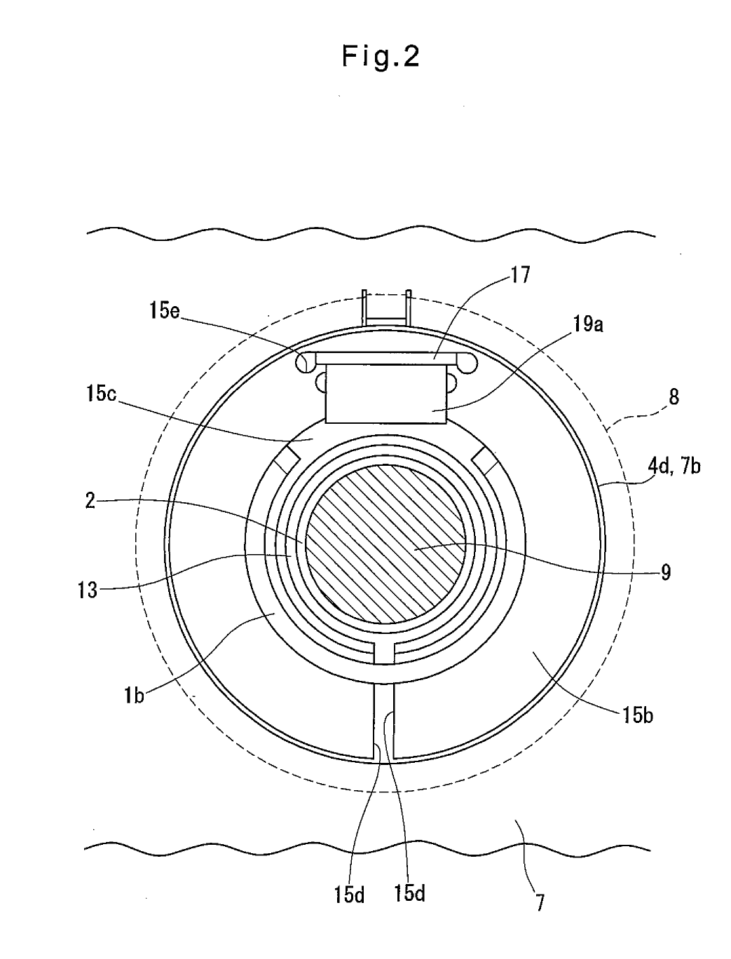

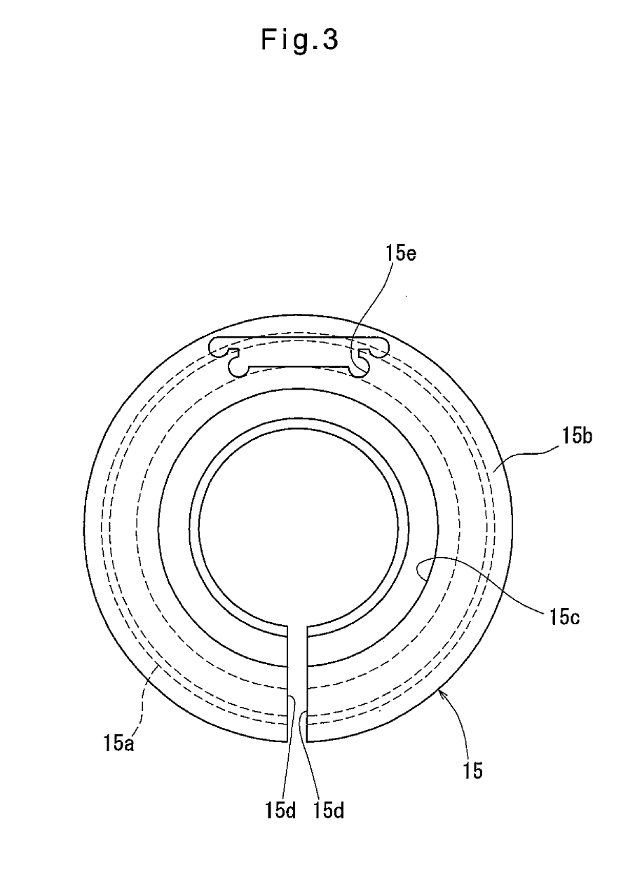

The sensor case 5 comprises a casing member 15 formed by injection molding, and a fixing auxiliary member 16. As shown in FIGS. 1 to 3, the casing member 15 is an annular member having circumferentially spaced apart ends 15d, and comprises a protrusion 15a fitted in the seal groove 4c of the outer race 4 at its first end, and an outer annular portion 15b supported in position on one side of the outer race 4 with the protrusion 15a fitted in the seal groove 4c. The casing member 15 is formed with a ring groove 15c opened to its first end.

By elastically deforming the entire casing member 15 such that its circumferentially spaced apart ends 15d are moved toward each other, the protrusion 15a, which is provided on the outer periphery of the casing member 15 at its second end so as to extend the entire circumference thereof, can be easily fitted in the seal groove 4c. The casing member 15 can be formed by injection-molding or hot-melting of a thermoplastic resin.

The fixing auxiliary member 16 is a snap ring adapted to be fitted in the ring groove 15c of the casing member 15 when the casing member 15 has been elastically deformed and then elastically returned to the original state. By fitting the fixing auxiliary member 16 with the protrusion 15a fitted in the seal groove 4c, the fixing auxiliary member 16 resists and prevents the deformation of the casing member 15 such that its circumferentially spaced apart ends 15d are moved toward each other. This keeps the protrusion 15a engaged in the seal groove 4c. The fixing auxiliary member 16 is not limited to a C-shaped concentric snap ring, and also may have a rectangular or circular cross-section. The fixing auxiliary member 16 may also be inserted between the circumferentially spaced apart ends 15d of the casing member 15.

The sensor case 5 is not limited to the one shown, but may e.g. comprises a metal core pressed into one end of the outer race, and an annular resin member mounted in the metal core for retaining a sensor board assembly, as disclosed in Patent document 1, or may comprise an endless annular casing member and include no fixing auxiliary member such that that the annular casing can be mounted to the outer race by pushing its protrusion into the seal groove.

As shown in FIGS. 1, 2 and 4, the sensor board assembly 6 comprises a circuit board 17, and a magnetic sensor 18 and a connector 19 mounted on the circuit board 17. The circuit board 17 is double-faced circuit board. The magnetic sensor 18 is an integrated circuit comprising a plurality of known sensor elements or sensor array. The front side 19a of the connector 19 has a connecting portion to which a wiring connector (shown by two-dot chain line in FIG. 1) extending from outside the sensor case 5 is connected. In this example, the connector 19 is a female connector into which the wiring connector is inserted. But the connecting portion may be a male connector instead. Wires including signal wires and a power source wire are preferably bundles into a single cable assembly so that the wires can be connected to the connecting portion at one time.

The connector 19 and the magnetic sensor 18 are mounted on the same side of the circuit board 17. It is preferable to use lead-free solder from the environmental viewpoint.

As shown in FIGS. 1 to 3, the casing member 15 has a blind hole 15e open radially inwardly and to the first end. The sensor board assembly 6 is inserted axially into the blind hole 15e from its first end, with the side of the circuit board on which the connector and the sensor are mounted facing radially inwardly. The portion of the sensor board assembly 6 located in the blind hole 15e is held in position in axial, radial and circumferential directions by the wall of the blind hole 15e.

In this state, the sensor board assembly 6 is sealed by resin molding. If the casing member 15 is formed by hot-melting, the sensor board assembly 6 may be formed so as to be integral with the casing member 15. If the connector 19 is omitted and terminals of wires are directly soldered to e.g. through holes of the circuit board 17, they should be soldered in the blind hole 15e, and after they are fixed in position, the portion of the sensor board assembly 6 located in the blind hole 15e should be completely embedded in resin, or embedded such that the sensor surfaces of the sensor 18 are exposed.

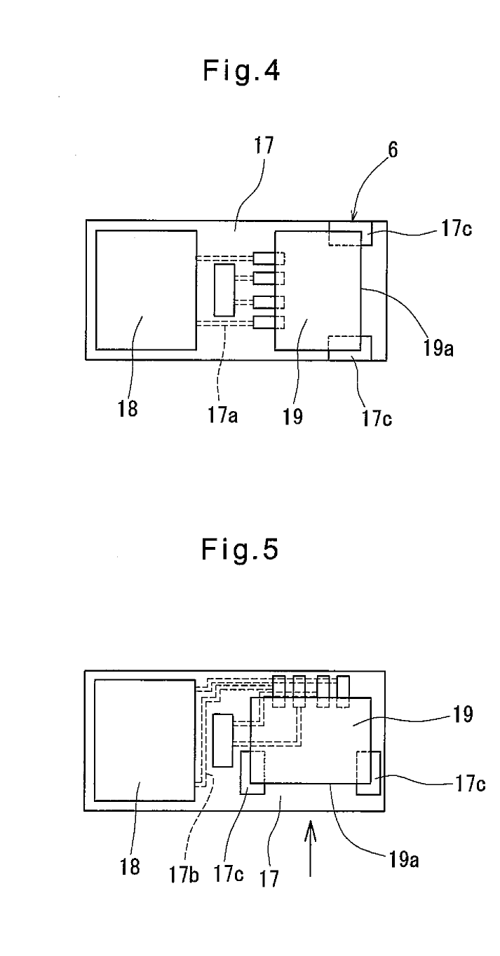

As shown in FIG. 4, the circuit board 17 has a first circuit pattern 17a on one side thereof which allows mounting of e.g. the magnetic sensor 18 and the connector 19 thereon, and as shown in FIG. 5, has a second circuit pattern 17b on the other side thereof which allows mounting of e.g. the magnetic sensor 18 and the connector 19 thereon.

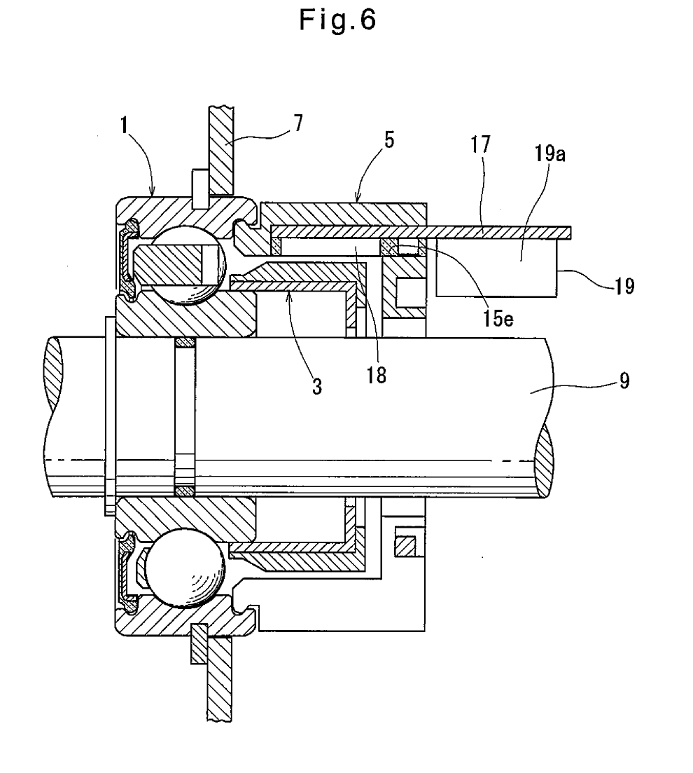

As shown in FIGS. 1 and 4, the first circuit pattern 17a is a printed circuit pattern which allows mounting of the connector 19 with its front side 19a facing toward one side. As shown in FIGS. 5 and 6, the second circuit pattern 17b is a printed circuit pattern which allows mounting of the connector 19 with its front side 19a facing in one of the directions perpendicular to the axis of the axial direction. The circuit patterns 17a and 17b are suitably determined taking into account how the terminal of the connector 19, mounting pads 17c, the elements of the magnetic sensor 18, etc. are connected together. If it is necessary or desired to mount the connector 19 in three or more different orientations, or on one side of the circuit so as to be positioned in a plurality of different orientations, or if the area of the circuit board for mounting the component parts is insufficient, and if the above requirements cannot be fulfilled simply by providing circuit patterns on both sides of a single-layered circuit board, a multi-layered circuit board may be used instead.

As will be apparent from comparison of FIG. 1 with FIG. 6, the circuit board 17 can be fixed to the sensor case 5 in the same manner, irrespective of which of the circuit patterns 17a and 17b is used. Thus, it is not necessary to change the portion of the circuit board 17 held by the casing member 15 depending on which of the circuit patterns 17a and 17b is used. Also, it is possible to freely change the shape of the circuit board 17 provided the positional relationship between the magnetic sensor 18 and the sensor case 5 is unchanged. In the example shown, the portion of the circuit board 17 located in and held in position by the blind hole 15e has identically shaped opposed sides. The portion of the circuit board 17 carrying the connector 19 is located outside of the sensor case 5. Thus this portion may have its both sides shaped differently from each other, unless both sides cannot be used due e.g. to interference with the sensor case 5. The specific circuit board 17 shown is rectangular in shape for simplicity, with the magnetic sensor 18 mounted on the center of its half portion at the second end, and the connector 19 mounted on the first end portion of circuit board 17.

By mounting the magnetic encoder member 3 on the outer periphery of the inner race 2 at its first end, and mounting the sensor case 5, to which the sensor board assembly 6 is fixed, on the inner periphery of the outer race 4 at its first end, the sensor surfaces of the magnetic sensor 19 face the magnetized portion 14 of the magnetic encoder member 3. In this state, the outer annular portion 15b and the magnetic encoder member 3 define a labyrinth seal. The sensor unit comprising the rolling bearing 1, the sensor case 5 and the sensor board assembly 6 is thus assembled. The sensor unit is mounted between the stationary member 7 and the rotary shaft 9 before the wires are connected to the connector 19.

The stationary member 7 is stationary relative to the rolling bearing 1, and comprises a thin plate, such as a steel plate formed by hot or cold rolling and having a thickness of less than 3.0 mm, or a coil or a cut plate formed by rolling flat and having a uniform section. It may be an electromagnetic soft iron material or an iron-nickel soft magnetic material having a width of more than 600 mm and a thickness of not more than 5 mm.

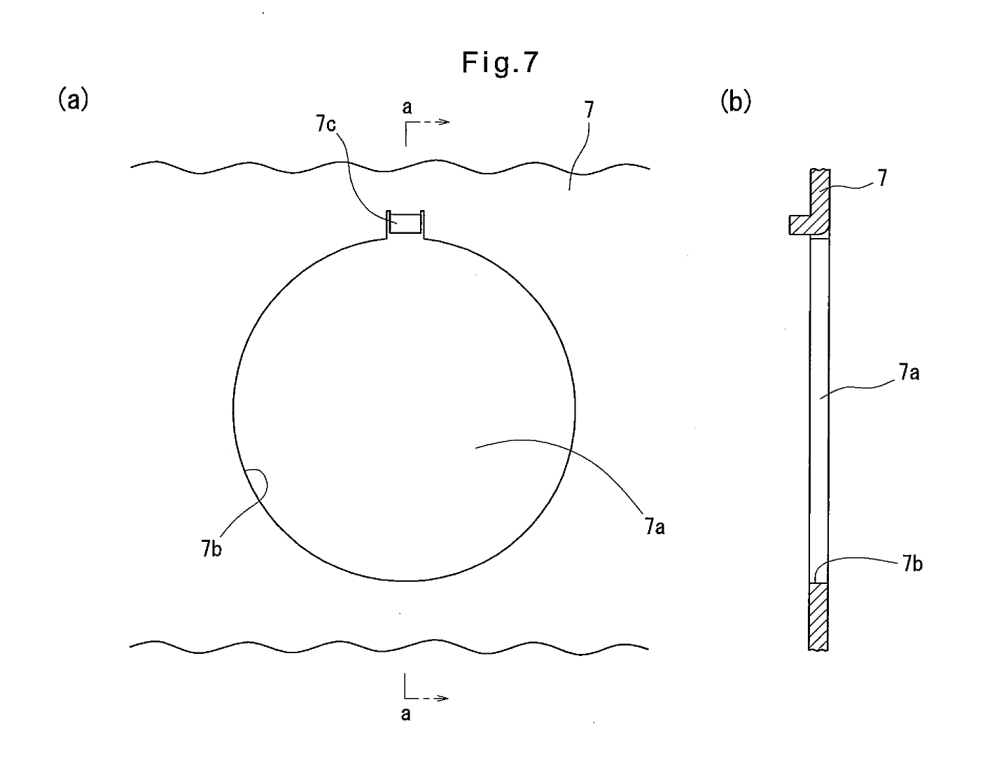

As shown in FIGS. 1 and 7, the stationary member 7 has a through hole 7a extending in the thickness direction of the stationary member 7, defining a radially inner portion 7b which can radially position the radially outer portion 4d of the outer race 4. The radially inner portion 7b is concentric with the central axis of the bearing. The radially inner portion 7b may have a large-diameter portion provided the radially inner portion 7b can radially position the radially outer portion 4d of the outer race. The through hole 7a can be most easily formed by pressing but may be formed in a different manner.

The radially outer portion 4d of the outer race 4 may be fitted in the radially inner portion 7b of the stationary member in any manner, including loose fit, ordinary fit and interference fit. Since it is difficult to stabilize the position of the sensor unit with the radially inner portion 7b of the stationary member 7 alone, it is possible to insert the radially outer portion 4d of the outer race 4 into the radially inner portion 7b by fitting the inner race 2 of the sensor unit on the rotary shaft 9 and axially inserting the sensor unit into the through hole 7a together with the rotary shaft 9.

The sensor case 5 and sensor board assembly 6 are shaped such that they can be passed through the through hole 7a of the stationary member 7 from either of the opposite axial directions. In the example shown, since the through hole 7a is a circular hole of which the center is located on the central axis of the bearing, the sensor case 5 and the sensor board assembly 6 are shaped so as not to radially protrude from a cylindrical space concentric with and having the same diameter as the outer diameter of the outer race 4. Thus, with the wires not connected, the sensor unit can be inserted into the through hole 7a of the stationary member 7 with either the rolling bearing 1 or the sensor case 5 first.

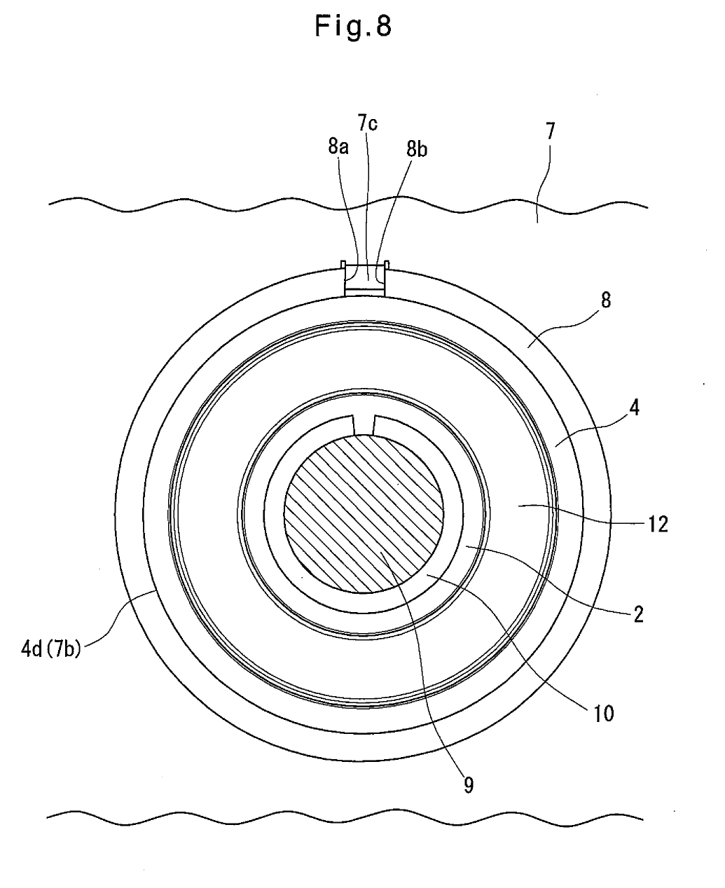

As shown in FIGS. 1 and 8, the sensor unit is fixed in position by the snap ring 8 fitted in the ring groove 4a of the outer race 4 and the shaft-side snap ring 10 fitted in the ring groove formed in the outer periphery of the rotary shaft 9 in both axial directions.

The snap ring 8 has circumferentially spaced apart ends 8a and 8b.

The stationary member 7 has an anti-rotation portion 7c protruding toward the snap ring 8. The anti-rotation portion 7c is a tongue portion formed when forming the through hole 7a and bent in the axial direction. The anti-rotation portion 7c has such a circumferential width that the anti-rotation portion 7c can be axially inserted between the circumferentially spaced apart ends 8a and 8b of the snap ring 8. The anti-rotation portion 7c is fitted between the ends 8a and 8b so that the circumferential positioning is achievable that will not interfere with the detection by the magnetic sensor 18. When the sensor unit is axially inserted into the through hole 7a, the anti-rotation portion 7c is axially aligned with the circumferentially spaced apart ends of the snap ring 8, which is fitted in the outer race 4 beforehand so that the anti-rotation portion 7c is inserted between the ends 8a and 8b of the snap ring 8 simultaneously when the sensor unit is inserted into the through hole 7a. But the snap ring 8 may be fitted on the outer race 4 after inserting the sensor unit. The anti-separation portion 7c may be formed by extruding the surface of the thin plate, instead of bending the tongue portion.

With the rolling bearing 1 positioned between the radially inner portion 7b of the stationary member 7 and the rotary shaft 9, with the snap ring 8, which is fitted on the outer race 4, in engagement with the surface of the stationary member 7 at the first end, and with the shaft-side snap ring 10, which is fitted on the rotary shaft 9, in engagement with the surfaced of the inner race 2 at the second end, the rolling bearing 1 is held in position in the radial and axial directions. In this assembled state, in which the rolling bearing 1 is disposed between the radially inner portion 7b of the stationary member 7 and the rotary shaft 9, the anti-rotation portion 7c, which is engaged between the circumferentially spaced apart ends 8a and 8b of the snap ring 8, never circumferentially disengages from the ends 8a and 8b. The snap ring 8 has sufficient fitting strength such that it can support torque from the outer race 4. In other words, when the outer race 4 is about to rotate in either direction, one of the circumferentially spaced apart ends 8a and 8b circumferentially engages the anti-rotation portion 7c, thereby preventing rotation the outer race 4. Although the snap ring 8 loosens in this state, it is of sufficient fitting strength that the snap ring 8 never rotates relative to the outer race 4. Since it is possible to increase the fitting strength of the snap ring 8 by improving its spring properties and rigidity, its fitting strength should be determined such that it can sufficiently support the torque from the outer race 4. The snap ring 8 shown is a C-shaped concentric ring used in a bearing. But if it can effectively axially position the sensor unit, its shape is not limited.

Relative rotation/slip between the inner race 2 and the rotary shaft 9 during use is prevented by the friction between the O-ring 11 and the radially inner portion of the inner race 2 and between the outer periphery of the rotary shaft 9 and the radially inner portion of the inner race 2. When the radially inner portion 2a of the inner race 2 is fitted around the rotary shaft 9 with the O-ring 11 fitted in the circumferential groove 9a on the outer periphery of the rotary shaft 9, the O-ring 11 is compressed by the radially inner portion 2a of the inner race 2. Due to the friction between the O-ring 11, which tends to expand due to its rubber elasticity, and the radially inner portion 2a, relative rotation between the inner race 2 and the rotary shaft 9 is more reliably prevented.

As described above, the stationary member 7 and the snap ring 8 are used to position the bearing assembly with the rotation sensor, while the sensor case 5 is used to position the sensor board assembly 6. Thus in the bearing assembly with the rotation sensor according to the first embodiment, since the rolling bearing 1 is positioned using the stationary member 7, which is a thin plate formed with the positioning through hole 7a extending in the thickness direction thereof, and the outer race 4 is kept from rotating using component parts of the bearing assembly with the rotation sensor and positioning members, the outer race 4 can be easily prevented from rotating.

In the bearing assembly with the rotation sensor according to the first embodiment, the outer race 4 is prevented from rotating simply by mounting the rolling bearing 1, with the anti-rotation portion 7c, which protrudes toward the snap ring 8, axially aligned with the circumferentially spaced apart ends 8a and 8b of the snap ring 8.

In the bearing assembly with the rotation sensor according to the first embodiment, since the circumferentially spaced apart ends of the snap ring 8, which is provided so that the snap ring can be easily fitted, are used as engaging portions too, the outer race can be prevented from rotating simply by forming the anti-separation portion 7c on the stationary member 7.

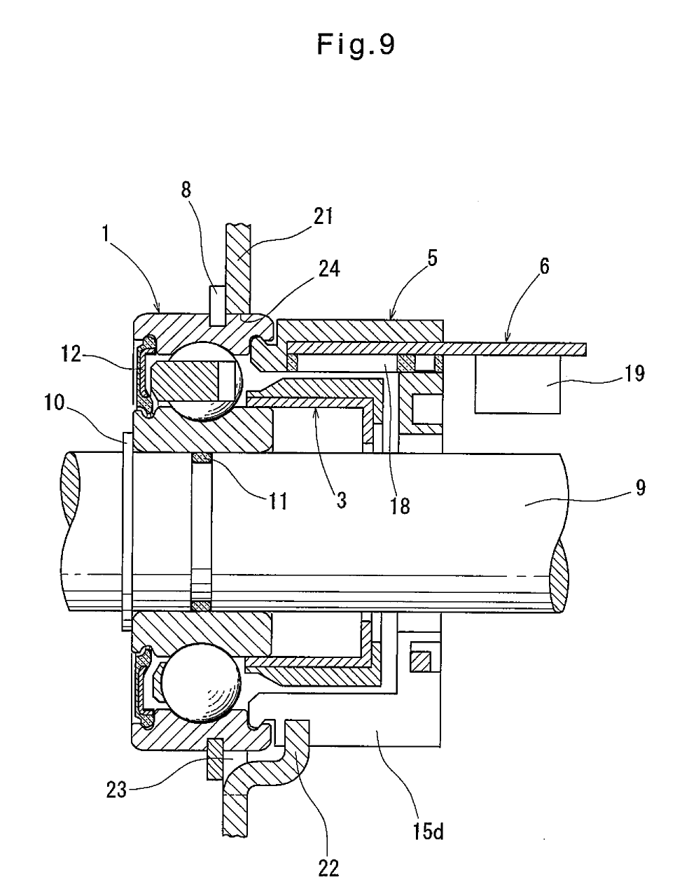

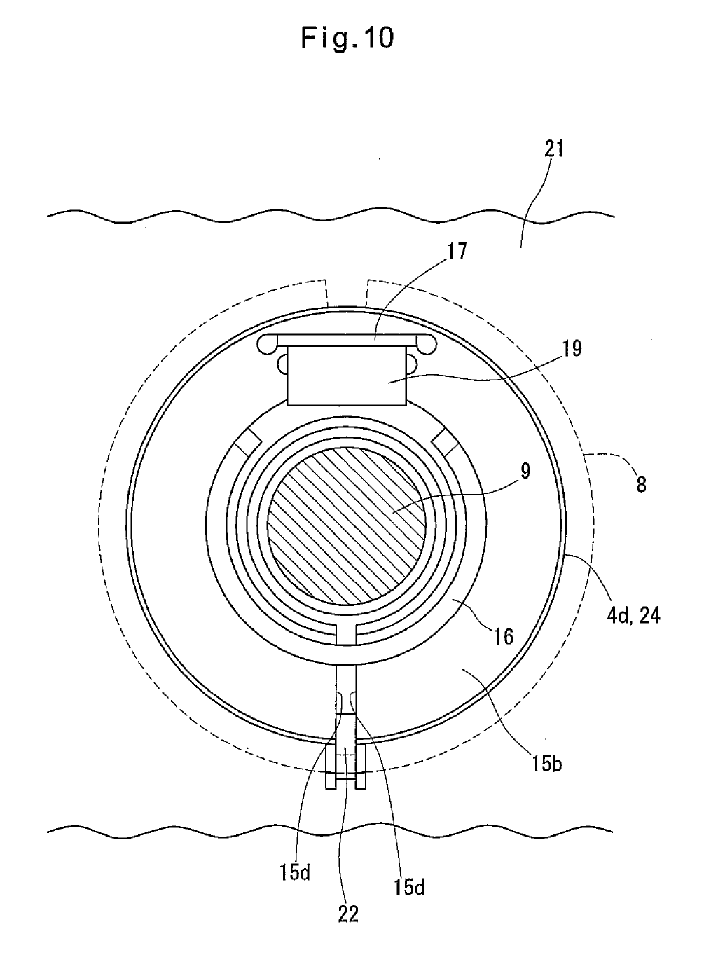

The bearing assembly with a rotation sensor according to the second embodiment is described with reference to FIGS. 9 and 10. This embodiment differs from the first embodiment in that the outer race 4 is prevented from rotating using the sensor case 5. Here, description is mainly made of what differs from the first embodiment.

As shown, the casing member 15 of the sensor case 5 has circumferentially spaced apart ends 15d. The stationary member 21 has an anti-rotation portion 22 protruding toward the sensor case 5. The anti-rotation portion 22 is axially inserted between the circumferentially spaced apart ends 15d of the sensor case 5, which protrudes from the outer race 4 to one side, the anti-rotation portion 22 is also bent so as to protrude toward the axis of the bearing from the radially outer surface of the outer race 4. The anti-rotation portion 22 is formed so that it is inserted between the circumferentially spaced apart ends of the casing member 15 by inserting the sensor unit into a through hole 23 formed in the stationary member 21 from the side of the sensor case 5. The anti-rotation portion 22 is fitted between the circumferentially spaced apart ends 15d of the casing member 15 in the same manner as in the first embodiment.

With the rolling bearing 1 mounted between the radially inner portion 24 of the stationary member 21 and the rotary shaft 9, the anti-rotation portion 22 circumferentially engages the circumferentially spaced apart ends 15d, thereby preventing the outer race 4 from rotating. Even when torque is applied to the sensor case 5 from the outer race 4, since the sensor case 5 is in engagement with the inner periphery of the outer race 5 at its first end, the friction between the sensor case 5 and the outer race 4 remains high. This prevents separation of the sensor case 5. Also, the high friction between the sensor case 5 and the outer race 4 prevents rotation of the sensor case 5 relative to the outer race 4. Since it is possible to increase the fitting strength of the sensor case 5 by improving the spring properties and rigidity of the casing member 15 and the fixing auxiliary member 16, its fitting strength should be determined such that it can sufficiently support the torque from the outer race 4.

In the bearing assembly with the rotation sensor according to the second embodiment, the outer race 4 is prevented from rotating simply by mounting the rolling bearing 1, with the anti-rotation portion 22, which protrudes toward the sensor case 5, axially aligned with the circumferentially spaced apart ends 15d of the sensor case 5. In the bearing assembly with the rotation sensor according to the second embodiment, since the circumferentially spaced apart ends of the sensor case 5, which is provided so that the sensor case 5 can be easily fitted, are used as engaging portions too, the outer race can be prevented from rotating simply by forming the anti-separation portion 22 on the stationary member 21.

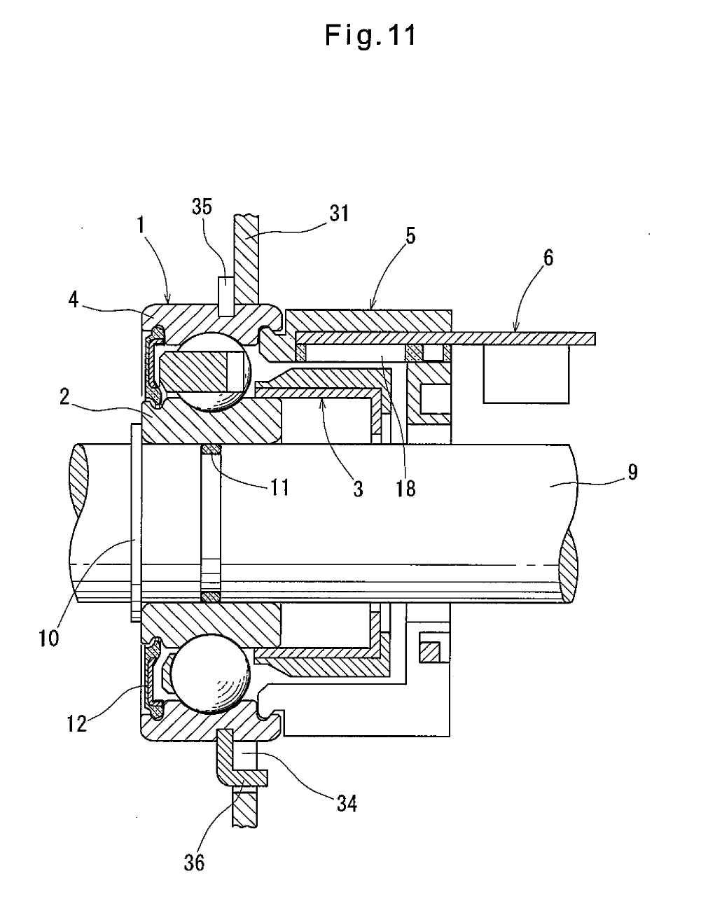

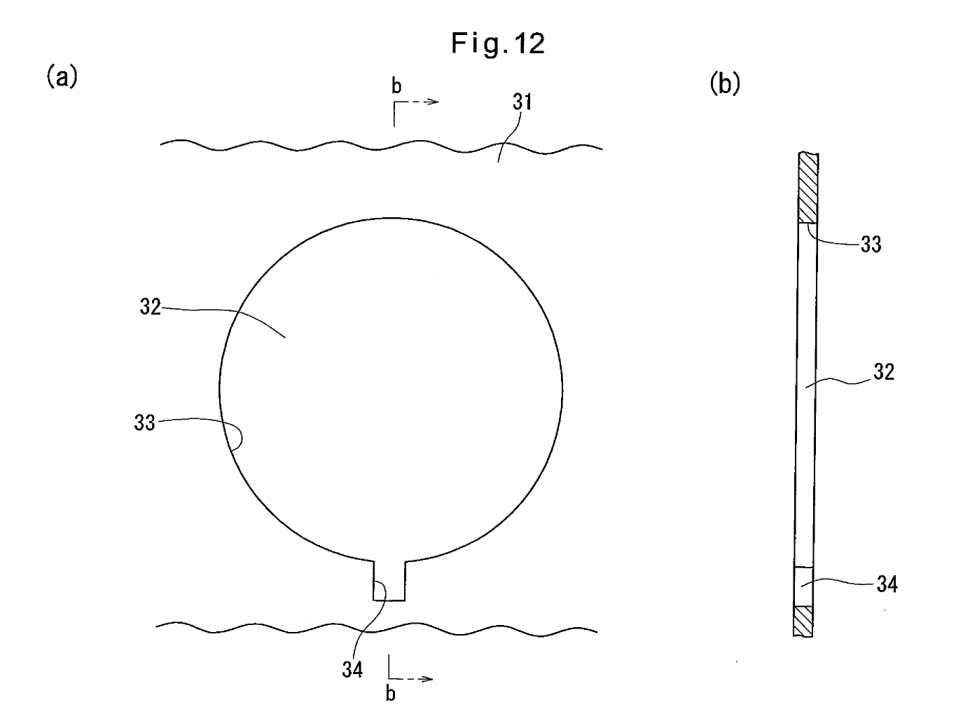

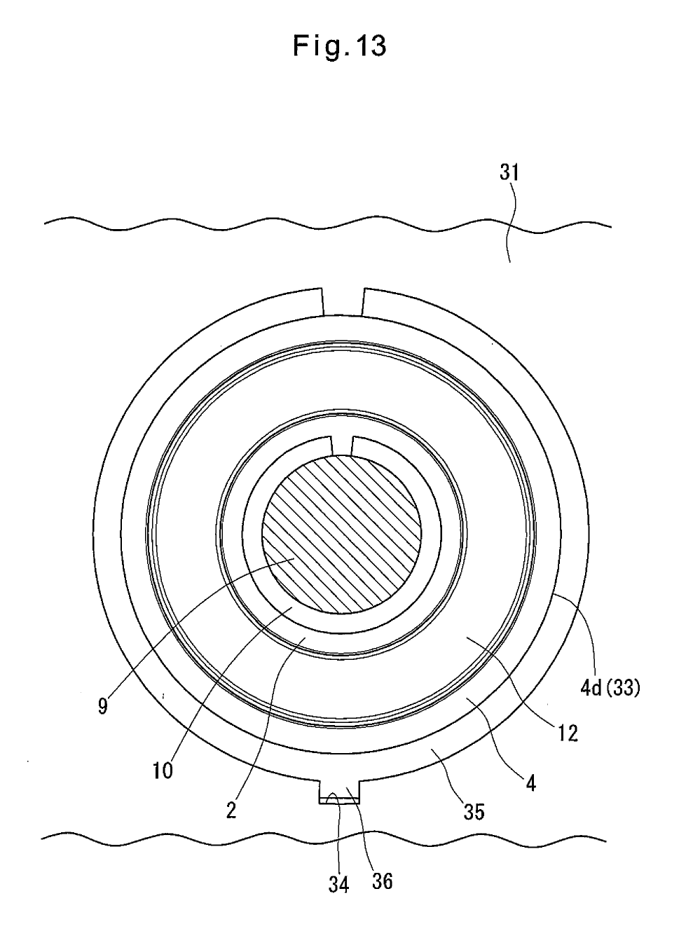

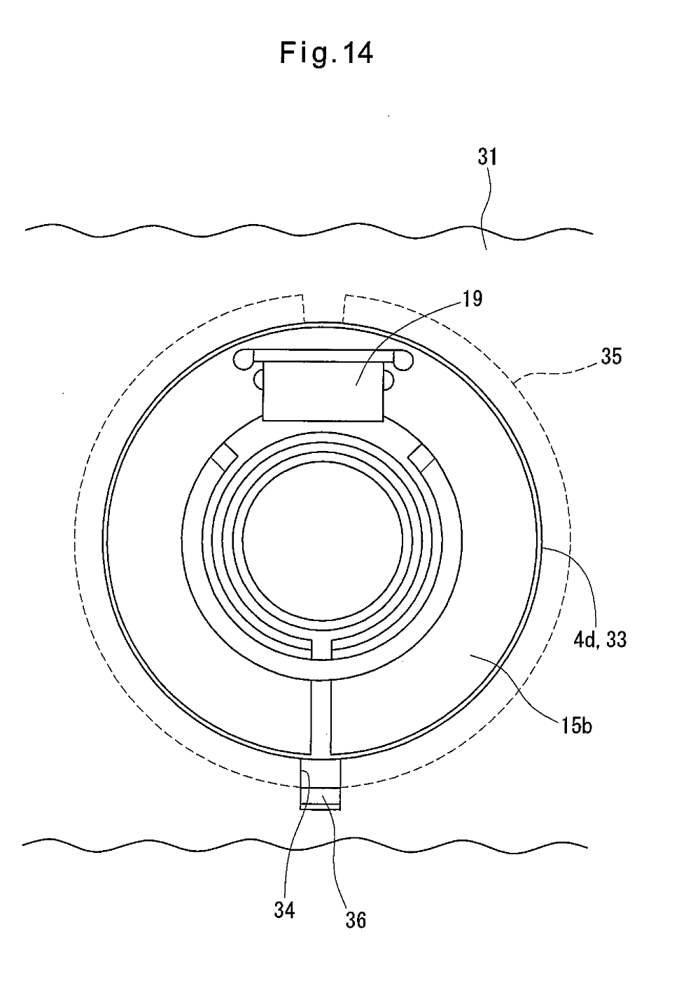

The bearing assembly with a rotation sensor according to the third embodiment is described with reference to FIGS. 11 to 14. As shown in FIGS. 11 and 12, the stationary member 31 of the third embodiment has a cutout 34 in the inner periphery of the through hole 32 that extends radially outwardly from the radially inner portion 33. The cutout 34 can be formed when forming the through hole 32. The snap ring 35 has an extension/protrusion 36 configured to be inserted into the cutout 34 when the sensor unit is inserted. The extension/protrusion 36 is formed by bending a tongue formed on the snap ring 35 diametrically opposite to the circumferentially spaced apart ends of the snap ring 35 toward the stationary member 31.

As shown I FIGS. 11, 13 and 14, with the rolling bearing 1 mounted between the radially inner portion 33 of the stationary member 31 and the rotary shaft 9, the extension/protrusion 36 of the snap ring 35 engages in the cutout 34, thereby preventing rotation of the outer race 4.

In order that the snap ring 35 can most strongly tighten the outer race 4 when torque is applied to the outer race 4, the extension/protrusion 36 is preferably formed diametrically opposite to the circumferentially spaced apart ends of the snap ring 35.

The cutout 34 can be formed when forming the through hole 32. Simply by mounting the rolling bearing 1 with the extension/protrusion 36 of the snap ring 35 axially aligned with the cutout 34 of the stationary member 31, the extension/protrusion 36 engages in the cutout 34, thereby preventing rotation of the outer race 4.

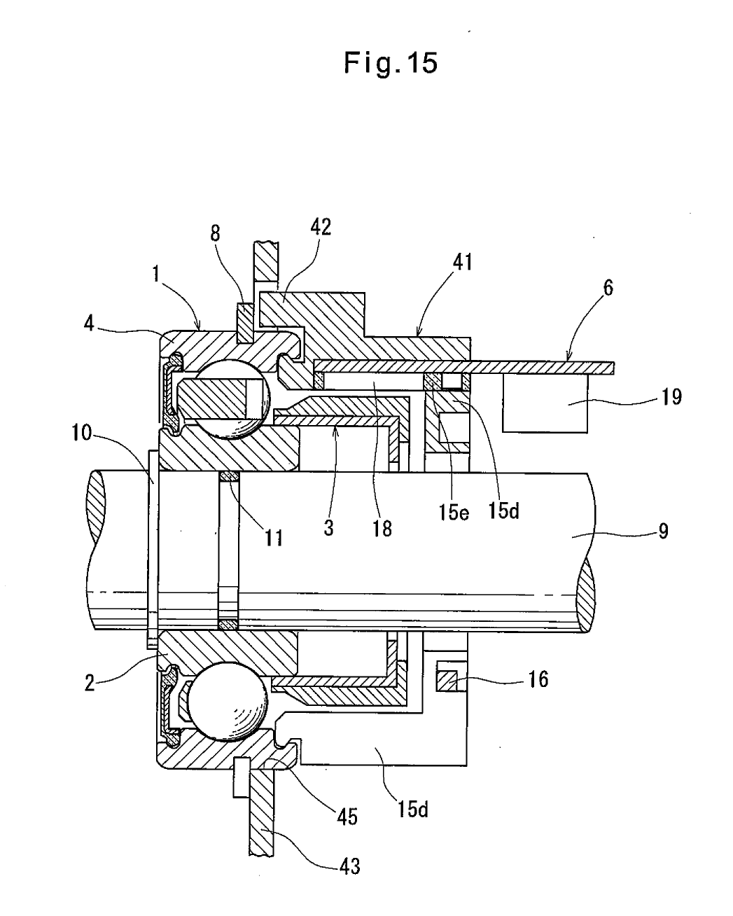

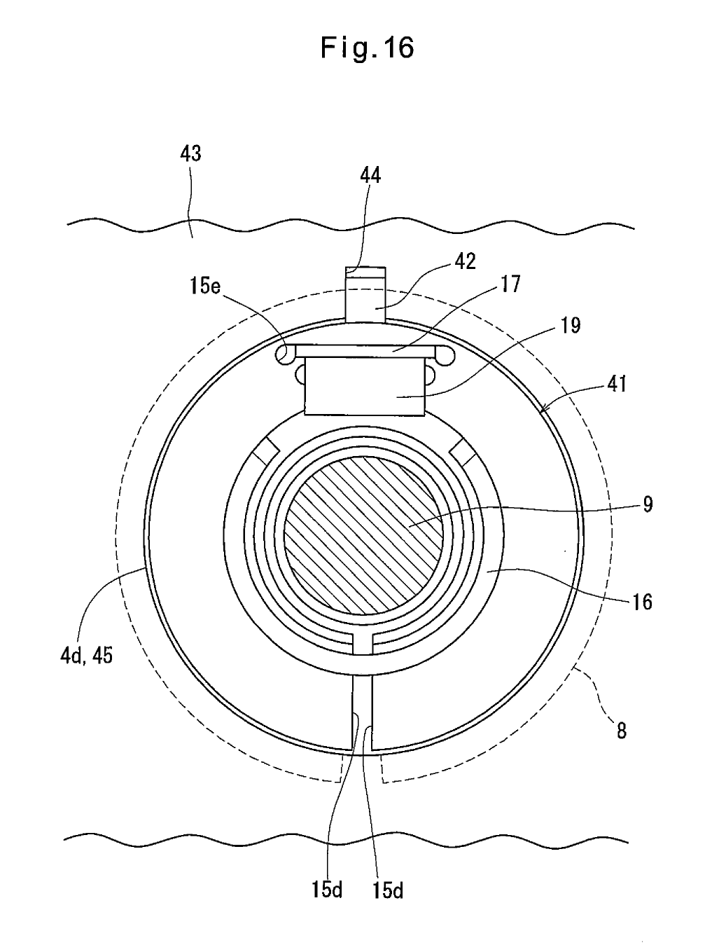

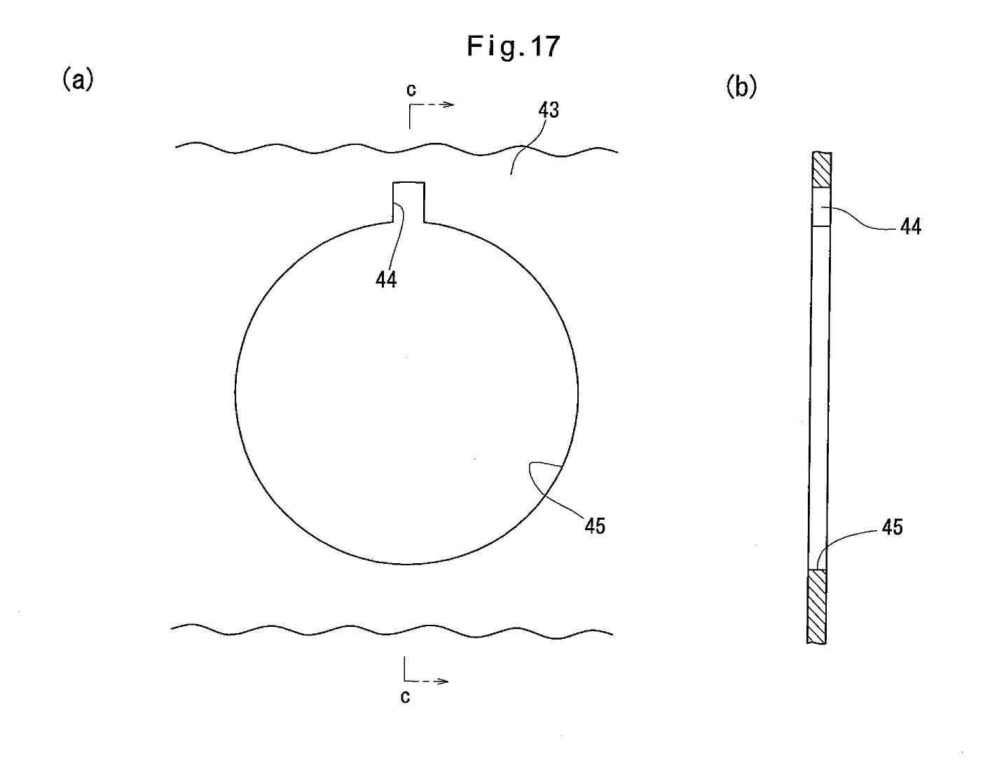

The bearing assembly with a rotation sensor according to the fourth embodiment is described with reference to FIGS. 15 to 17. In the bearing assembly of the fourth embodiment, instead of the extension/protrusion of the snap ring of the third embodiment, an extension/protrusion 42 is formed on the sensor case 41. Below description is made of how the fourth embodiment differs from the third embodiment.

As shown, the extension/protrusion 42 of the sensor case 41 extends to around the radially outer portion 4d of the outer race 4 so that it can be axially inserted into a cutout 44 formed in the stationary member 43. The extension/protrusion 42 is formed as part of the casing member.

With the rolling bearing 1 mounted between the radially inner portion 45 of the stationary member 43 and the rotary shaft 9, the cutout 44 and the extension/protrusion 42 circumferentially engage each other, thereby preventing rotation of the outer race 4.

In order to prevent deflection of a circumferential half portion of the casing member when torque acts on the outer race 4, the extension/protrusion 42 is preferably formed at a position diametrically opposite to the circumferentially spaced apart ends of the casing member.

When comparing the third and fourth embodiments with the first and second embodiments, the first and second embodiments are more preferable because it is not necessary to remove the material of the thin plate to form the cutout as the anti-separation portion when forming the through hole, and also it is not necessary to provide the snap ring or to form the protrusion/extension on the sensor case.

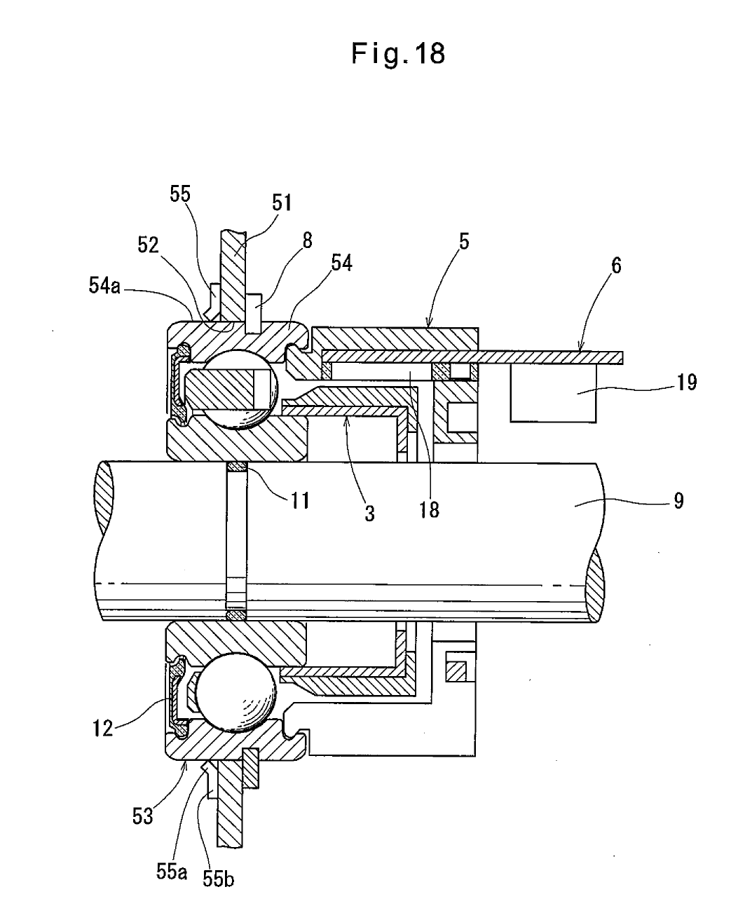

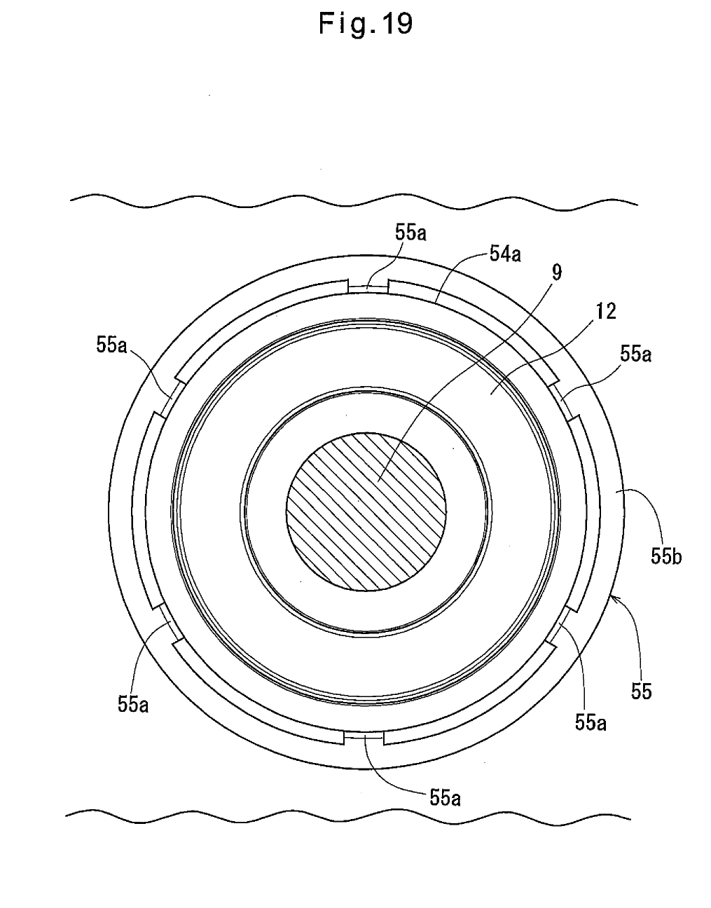

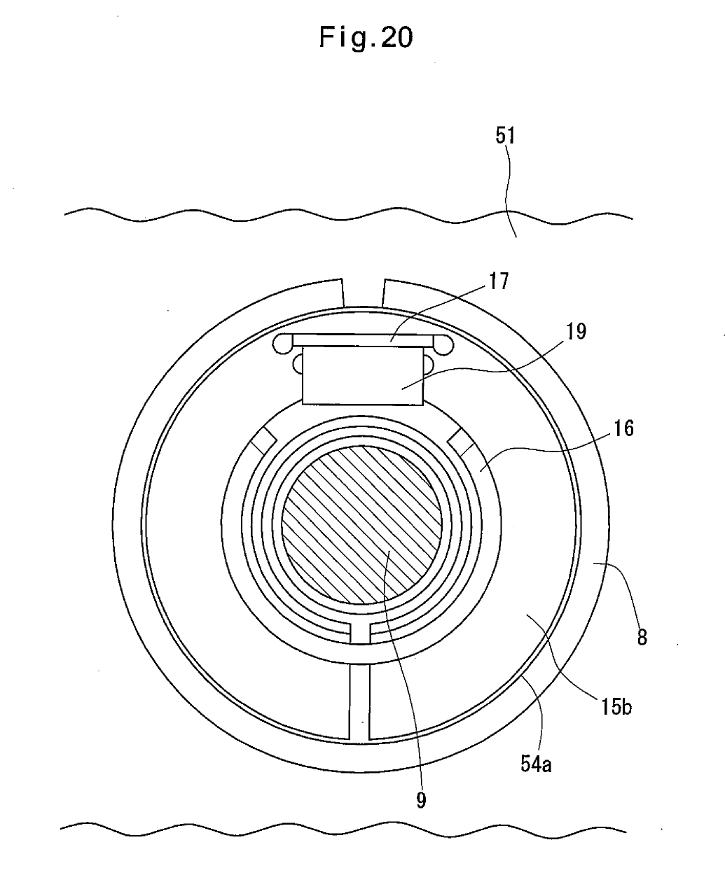

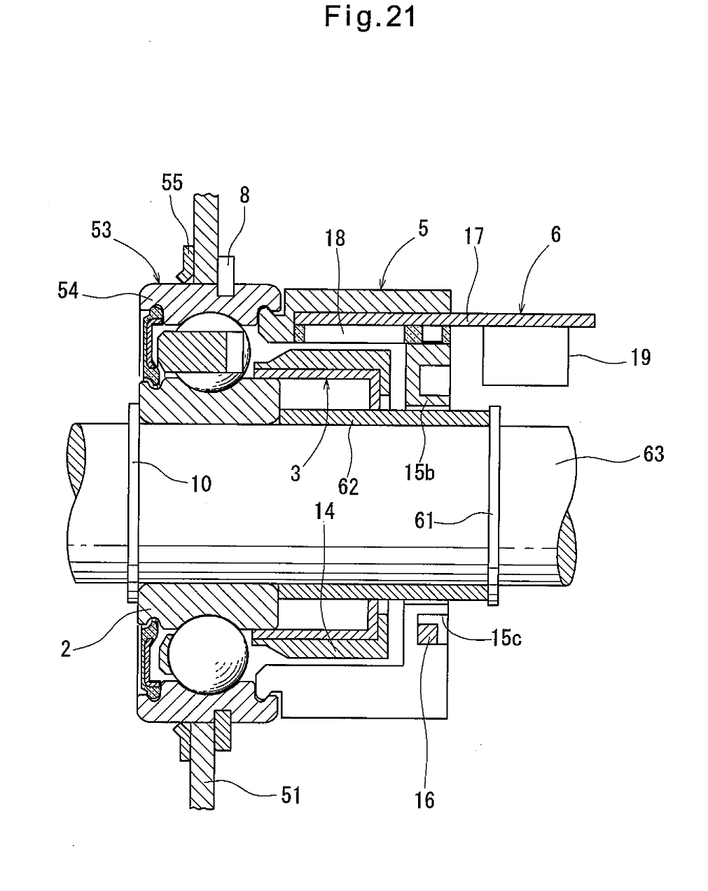

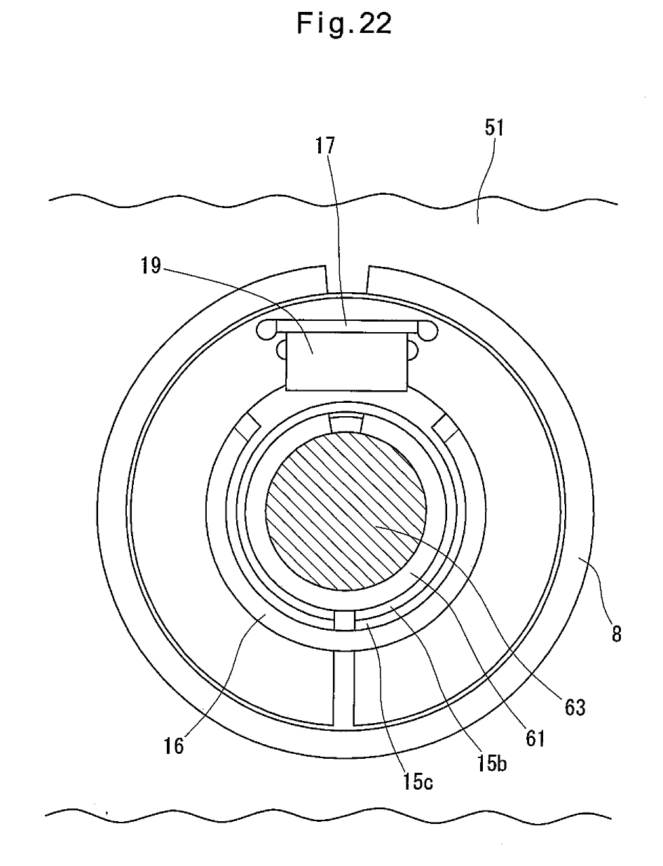

The bearing with a rotation sensor according to the fifth embodiment is described with reference to FIGS. 18 to 20. As shown, the bearing with a rotation sensor according to the fifth embodiment includes a second snap ring 55 configured to be fitted onto an outer race 54 of a rolling bearing 53 with the rolling bearing 53 inserted between a radially inner portion 52 of a stationary member 51 and the rotary shaft 9. The stationary member 51 has neither an anti-rotation portion nor a cutout. The snap ring 8 is fitted in a ring groove formed in the outer race 54 at the first end thereof. The second snap ring 55 is an endless annular member having three or more circumferentially equidistantly spaced apart spring pieces 55a which are adapted to be elastically deformed when the snap ring 55 is pressed onto the radially outer portion 54a of the outer race 54, so that its radially outer portion 55b is pressed against the second side of the stationary member 51.

When the second snap ring 55 is fitted onto the outer race with the snap ring 8 fitted on the outer race, the second snap ring 55 pushes the stationary member 51 toward the snap ring 8 until the stationary member 51 is sandwiched between the second snap ring 55, which is pressed against the second side of the stationary member, and the snap ring 8, which is pressed against the one side of the stationary member. Thus, the outer race 54 is axially fixed in position, and thus the rolling bearing 53 is axially fixed in position with the rolling bearing 53 mounted between the radially inner portion 52 of the stationary member 51 and the rotary shaft 9. In this state, the frictional engagement between the snap rings 8 and 55 and the stationary member 51 prevents rotation of the outer race 54.

With the bearing with a rotation sensor according to the fifth embodiment, since the stationary member is simply sandwiched between the snap rings 8 and 55, this arrangement does not limit the circumferential position of the rolling beating 53 when the rolling bearing 53 is inserted into the through hole of the stationary member 51, as in the case of the anti-rotation portion and the circumferentially spaced apart ends or the cutout and the extension/protrusion of the first to fourth embodiments.

The arrangement of sandwiching the stationary member with the snap rings 8 and 55 may be used in combination with the anti-rotation means of the first to fourth embodiments.

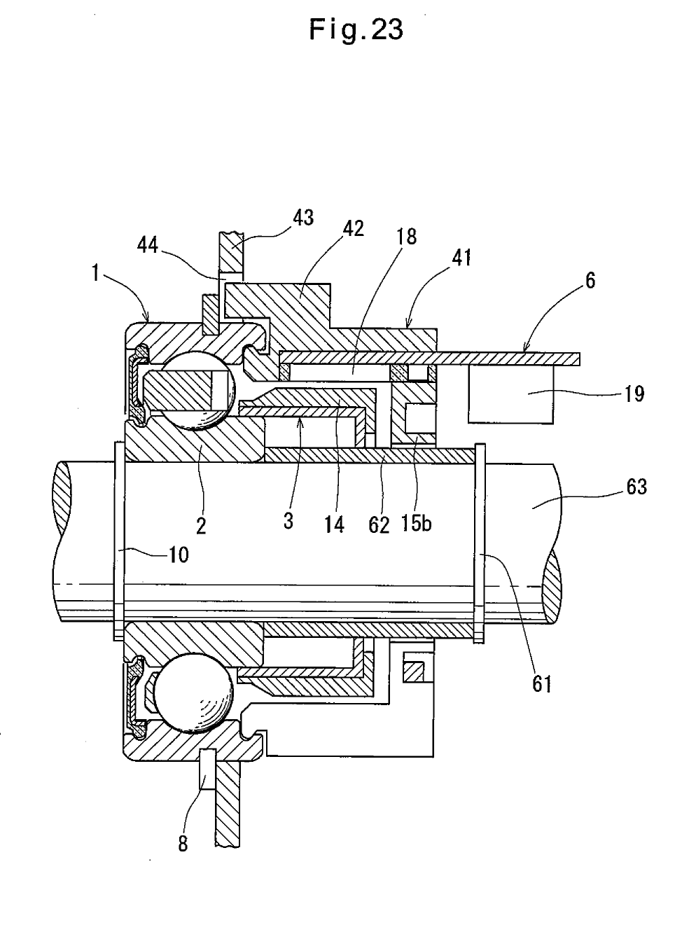

FIGS. 22 and 23 show the bearing with a rotation sensor according to the sixth embodiment, in which instead of the O-ring of the fifth embodiment, a pair of shaft-side snap rings 10 and 61 and a sleeve 62 are used to prevent relative rotation.

As shown, the snap rings 10 and 61 are fixed in position on the rotary shaft 63, and the sleeve 62 is fitted on the rotary shaft 63. An additional shaft-side snap 61 is also fitted in a ring groove formed in the outer periphery of the rotary shaft 63. The sleeve 62 is configured such that when fitted on the rotary shaft 63, the sleeve 62 extends between the magnetized portion 14 of the magnetic encoder member 3 and the rotary shaft 63 and between the outer annular portion 15b of the sensor case 5 and the rotary shaft 63, and abuts the first end of the inner race 2. The sleeve 62 may be fitted on the rotary shaft 63 either before or after the inner race 2 is fitted on the rotary shaft 63. By fitting the snap rings 10 and 61 after the sleeve 62 and the inner race 2 are fitted on the rotary shaft 63, the snap rings 10 and 61 are deflected, so that the inner race 2 and the sleeve 62 are pressed by the snap rings 10 and 61 from both sides. Thus, the friction between the snap ring 10 and the second end of the inner race 2 and between the first end of the inner race 2 and the sleeve 62 prevents relative rotation between the inner race 2 and the rotary shaft 63.

Means for preventing relative rotation between the inner race 2 and the rotary shaft 63 is not limited to those of the first and sixth embodiments, and any suitable such means can be selected independently of the anti-rotation means of the outer race. For example, as shown in FIG. 23, the means for preventing relative rotation used in the sixth embodiment may be used in combination with the anti-rotation means for the outer ring of the fourth embodiment, which comprises the extension/protrusion 42 of the sensor case 41 and the cutout 44.

The present invention is not limited to the above embodiments but contains all the possible modifications that read on claims.

### DESCRIPTION OF THE NUMERALS

1, 53. Rolling bearing
2. Inner race
2a. Radially inner portion
3. Magnetic encoder member
4, 54. Outer race
4a. Ring groove
4d, 54a. Radially outer portion
5, 41. Sensor case
6. Sensor board assembly
7, 21, 31, 43, 51. Stationary member
7a, 23, 32. Through hole
7b, 24, 33, 45, 52. Radially inner portion
7c, 22. Anti-rotation portion
8, 35. Snap ring
9, 63. Rotary shaft
9a. Outer peripheral circumferential groove
10, 61. Shaft-side snap ring
11. O-ring
14. Magnetized portion
15. Casing member
15b. Outer annular portion
8a, 8b, 15d. Circumferentially spaced apart end
16. Fixing auxiliary member
17. Circuit board
17a. First circuit pattern
17b. Second circuit pattern
18. Magnetic sensor
19. Connector
19a. Front side
34, 44. Cutout
36, 42. Extension/protrusion.
55. Second snap ring
55a. Spring piece
55b. Radially outer portion
62. Sleeve

1. A bearing assembly with a rotation sensor comprising a rolling bearing including an inner race and an outer race, a magnetic encoder member mounted to the inner race at a first end of the bearing, a sensor case mounted to the outer race at the first end of the bearing, and a sensor board assembly fixed to the sensor case,
wherein the magnetic encoder member includes a magnetized portion including a plurality of magnetic poles arranged in the circumferential direction,
wherein the sensor board assembly comprises a circuit board and a magnetic sensor mounted on the circuit board, and
wherein the sensor case is mounted such that the magnetic sensor faces the magnetized portion,
characterized in that the bearing assembly further comprises a stationary member comprising a thin plate member formed with a through hole extending in the thickness direction of the thin plate member and defining a radially inner portion capable of radially positioning a radially outer portion of the outer race of the rolling bearing, and a first snap ring fitted in a ring groove formed in the outer race of the rolling bearing, and
that with the rolling bearing mounted between the radially inner portion of the stationary member and a rotary shaft, the stationary member is configured to engage one of the first snap ring and the sensor case so as to prevent rotation of the outer race of the rolling bearing.

2. The bearing assembly of claim 1, wherein the stationary member includes an anti-rotation portion protruding toward one of the first snap ring and the sensor case,
wherein said one of the first snap ring and the sensor case is formed with circumferentially spaced apart ends, and
wherein the anti-rotation portion is configured to circumferentially engage one of the circumferentially spaced apart ends, thereby preventing rotation of the outer race of the rolling bearing.

3. The bearing assembly of claim 2, wherein the first snap ring is formed with the circumferentially spaced apart ends, and
wherein the anti-rotation portion is configured to be inserted between the circumferentially spaced apart ends.

4. The bearing assembly of claim 2, wherein the sensor case comprises an annular casing member formed with the circumferentially spaced apart ends, and an fixing auxiliary member,
wherein the casing member has a protrusion fitted in a seal groove formed in the outer race at the first end thereof,
wherein with the protrusion fitted in the seal groove, the fixing auxiliary member is configured to prevent deformation of the casing member such that the circumferentially spaced apart ends move toward each other, thereby keeping the protrusion in the seal groove, and
wherein the anti-rotation portion is configured to be inserted between the circumferentially spaced apart ends of the sensor case.

5. The bearing assembly of claim 1, wherein the stationary member is formed with a cutout in the inner periphery of the through hole so as to extend radially outwardly from the radially inner portion, and
wherein said one of the first snap ring and the sensor case is formed with an extension/protrusion configured to be inserted into the cutout,
whereby the outer race of the rolling bearing is prevented from rotating by the engagement between the cutout and the extension/protrusion.

6. The bearing assembly of claim 1, further comprising a second snap ring configured to be fitted around the outer race of the rolling bearing with the rolling bearing mounted between the radially inner portion of the stationary member and the rotary shaft,
wherein the first and second snap rings engage two opposed sides of the stationary member so as to sandwich the stationary member, thereby preventing rotation of the outer race of the rolling bearing due to friction between the first and second snap rings and the stationary member.

7. The bearing assembly of claim 1, wherein the magnetized portion of the magnetic encoder member is supported on one side of the outer periphery of the inner race of the rolling bearing, and the sensor case has an outer annular portion supported on one side of the inner periphery of the outer race of the rolling bearing,
wherein the bearing assembly further comprises a pair of shaft-side snap rings fitted on the rotary shaft, and a sleeve fitted on the rotary shaft, wherein the sleeve is configured to be inserted between the sensor case and the rotary shaft and between the magnetic encoder member and the rotary shaft until the sleeve abuts the inner race of the rolling bearing,
wherein the pair of shaft-side snap rings sandwich the inner race and the sleeve together, thereby preventing rotation of the inner race relative to the rotary shaft due to friction between one of the shaft-side snap rings and the inner race and between the other of the shaft-side snap rings and the sleeve.

8. The bearing assembly claim 1, further comprising an O-ring fitted in a circumferential groove formed in the outer periphery of the rotary shaft,
wherein the O-ring is compressed by a radially inner portion of the inner race of the rolling bearing, whereby the inner race is prevented from rotating relative to the rotary shaft due to friction between the O-ring and the radially inner portion of the inner race.

9. The bearing assembly of claim 1, wherein the sensor board assembly further comprises a connector to which a wiring connector is connected from outside the sensor case and mounted on the same side of the circuit board that the magnetic sensor is mounted.

10. The bearing assembly of claim 9, wherein the circuit board has a first circuit pattern on which the connector can be mounted with its front side facing toward one side, and a second circuit pattern on which the connector can be mounted with its front side facing in a direction perpendicular to the axis of the bearing assembly, and wherein the circuit board is configured such that the positional relationship between the magnetic sensor and the sensor case when the connector is mounted on the first circuit pattern is identical to the positional relationship between the magnetic sensor and the sensor case when the connector is mounted on the second circuit pattern.

11. The bearing assembly of claim 10, wherein the magnetic sensor and the connector can be mounted on either of the first and second circuit patterns, and wherein the first and second circuit patterns are provided on one and the other sides of the circuit board, respectively.

12. The bearing assembly of claim 9, wherein the sensor case and the sensor board assembly are configured such that the sensor case and the sensor board assembly can be inserted through the through hole of the stationary member from either of the opposed axial directions.

13. The bearing assembly of claim 2, wherein the magnetized portion of the magnetic encoder member is supported on one side of the outer periphery of the inner race of the rolling bearing, and the sensor case has an outer annular portion supported on one side of the inner periphery of the outer race of the rolling bearing,
wherein the bearing assembly further comprises a pair of shaft-side snap rings fitted on the rotary shaft, and a sleeve fitted on the rotary shaft, wherein the sleeve is configured to be inserted between the sensor case and the rotary shaft and between the magnetic encoder member and the rotary shaft until the sleeve abuts the inner race of the rolling bearing,
wherein the pair of shaft-side snap rings sandwich the inner race and the sleeve together, thereby preventing rotation of the inner race relative to the rotary shaft due to friction between one of the shaft-side snap rings and the inner race and between the other of the shaft-side snap rings and the sleeve.

14. The bearing assembly of claim 5, wherein the magnetized portion of the magnetic encoder member is supported on one side of the outer periphery of the inner race of the rolling bearing, and the sensor case has an outer annular portion supported on one side of the inner periphery of the outer race of the rolling bearing,
wherein the bearing assembly further comprises a pair of shaft-side snap rings fitted on the rotary shaft, and a sleeve fitted on the rotary shaft, wherein the sleeve is configured to be inserted between the sensor case and the rotary shaft and between the magnetic encoder member and the rotary shaft until the sleeve abuts the inner race of the rolling bearing,
wherein the pair of shaft-side snap rings sandwich the inner race and the sleeve together, thereby preventing rotation of the inner race relative to the rotary shaft due to friction between one of the shaft-side snap rings and the inner race and between the other of the shaft-side snap rings and the sleeve.

15. The bearing assembly of claim 6, wherein the magnetized portion of the magnetic encoder member is supported on one side of the outer periphery of the inner race of the rolling bearing, and the sensor case has an outer annular portion supported on one side of the inner periphery of the outer race of the rolling bearing,
wherein the bearing assembly further comprises a pair of shaft-side snap rings fitted on the rotary shaft, and a sleeve fitted on the rotary shaft, wherein the sleeve is configured to be inserted between the sensor case and the rotary shaft and between the magnetic encoder member and the rotary shaft until the sleeve abuts the inner race of the rolling bearing,
wherein the pair of shaft-side snap rings sandwich the inner race and the sleeve together, thereby preventing rotation of the inner race relative to the rotary shaft due to friction between one of the shaft-side snap rings and the inner race and between the other of the shaft-side snap rings and the sleeve.

16. The bearing assembly of claim 2, further comprising an O-ring fitted in a circumferential groove formed in the outer periphery of the rotary shaft,
wherein the O-ring is compressed by a radially inner portion of the inner race of the rolling bearing, whereby the inner race is prevented from rotating relative to the rotary shaft due to friction between the O-ring and the radially inner portion of the inner race.

17. The bearing assembly of claim 5, further comprising an O-ring fitted in a circumferential groove formed in the outer periphery of the rotary shaft,
wherein the O-ring is compressed by a radially inner portion of the inner race of the rolling bearing, whereby the inner race is prevented from rotating relative to the rotary shaft due to friction between the O-ring and the radially inner portion of the inner race.

18. The bearing assembly of claim 6, further comprising an O-ring fitted in a circumferential groove formed in the outer periphery of the rotary shaft,
wherein the O-ring is compressed by a radially inner portion of the inner race of the rolling bearing, whereby the inner race is prevented from rotating relative to the rotary shaft due to friction between the O-ring and the radially inner portion of the inner race.

19. The bearing assembly of claim 7, further comprising an O-ring fitted in a circumferential groove formed in the outer periphery of the rotary shaft,
wherein the O-ring is compressed by a radially inner portion of the inner race of the rolling bearing, whereby the inner race is prevented from rotating relative to the rotary shaft due to friction between the O-ring and the radially inner portion of the inner race.

20. The bearing assembly of claim 2, wherein the sensor board assembly further comprises a connector to which a wiring connector is connected from outside the sensor case and mounted on the same side of the circuit board that the magnetic sensor is mounted.
